(19) United States
(12) Patent Application Publication
(10) Pub. No.: US 2018/0300432 A1
(43) Pub. Date: Oct. 18, 2018

(54) SYSTEM AND METHOD FOR MODELING STAIRS

(71) Applicant: GRAPHISOFT SE, Budapest (HU)

(72) Inventors: Kristóf Rigó, Budapest (HU); Gergely Zsolt Hári, Budapest (HU); Péter Bakos, Budapest (HU)

(21) Appl. No.: 15/807,324

(22) Filed: Nov. 8, 2017

Related U.S. Application Data
(60) Provisional application No. 62/486,587, filed on Apr. 18, 2017.

(51) Int. Cl. G06F 17/50; G06F 3/0484

(52) U.S. Cl. CPC G06F 17/5004; G06F 3/04842; G06Q 10/067; G06F 2217/02; G06F 2217/06

(57) ABSTRACT

A stair modeling system having a storage resource with standard stair design values stored in the storage resource and a processor. The processor executes application code instructions to cause the system to receive user defined standard stair design values and user defined stair design values. The instructions further cause the system to generate stair design data associated with dynamically manageable and displayable objects, the stair design data and control data defined by at least one of the user defined standard stair design values and the user defined stair design values. The instructions further cause the system to process the stair design data and control data by comparing the user defined standard stair design values and the user defined stair design values with the standard stair design values and recalculate the user defined standard stair design values and user defined stair design values, and automatically regenerate stair design data.

### CROSS REFERENCE TO RELATED APPLICATION

This application claims priority to U.S. Provisional Patent Application No. 62/486,587, filed Apr. 18, 2017, entitled “Stair Solver,” the entire contents of which are hereby fully incorporated herein by reference.

### TECHNICAL FIELD

The present disclosure relates generally to computer aided designs and, more specifically, to stair design modeling algorithms for business management information tools.

### BACKGROUND

Architectural design of buildings requires a great deal of knowledge and understanding of architectural details and their applications and limitations of use. Business information management tools can be used to assist the architect in the design choices and their applications and limitations of use. There are other non-technical aspects of the design that can govern and limit the architectural solution. An architect must also meet standard design requirements and limitations imposed by government authorities and adhere to other rules and best practices that may be traditional for a locality. The architectural design process can be complex and trying to satisfy the commercial needs as well as the authoritative standard requirements and industry best practices can be very time consuming and can result in miscalculations and possible errors or violations of the standard requirements. Although there are business information management tools available to assist in the design process, these tools lack essential features needed to assist an architect to address the commercial needs as well as the standards and rules needed to design a solution that meets these additional requirements.

### SUMMARY

Techniques herein provide a computer-implemented system and method to model stairs. The computer-implemented system and method includes a computer-usable non-transitory storage resource, standard stair design parameters and associated values stored in the storage resource, and a processor communicatively coupled to the storage resource, wherein the processor executes application code instructions that are stored in the storage resource to cause the system to automatically generate alternate stair design values based on pre-stored standard defined values and pre-entered user defined values received in real-time.

In one aspect, the system is configured to receive at least one of standard stair design parameter and associated user defined value and at least one stair design parameter and associated user defined value; generate stair design data associated with dynamically manageable objects, each object displayable within a graphical setting, the stair design data defined at least partially by at least one of the standard stair design parameter and associated user defined value and the at least one stair design parameter and associated user defined value; process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters; and automatically regenerate stair design data.

In another aspect, the standard stair design parameters and associated values define parameters and values for at least one of riser height, going width, 2 times riser plus 1 going, a riser/going ratio, riser plus going, stair pitch, walking line, and automatic landing length; and the standard stair design parameters and associated user defined values and stair design parameters and associated user defined values define parameters and values for at least one of riser height, going width, 2 times riser plus 1 going, a riser/going ratio, riser plus going, stair pitch, and automatic landing length, story height, number of landings, landing types (landing, winder with equal angles, winder with equal goings) and parameters, segment types (run, landing, winder with equal angles, winder with equal goings) and parameters, number of steps, stair width, number of risers, position of walking line and polyline geometry values.

In yet another aspect, the system is configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of: iteratively adjust size of at least one going; automatically calculate lead and trail offsets for each turnings within the standard requirements; and adjust length of polyline segments while keeping the segment directions intact.

In another aspect, the system is configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of: if there are at least 3 segments in a stair and the turning types are landings, then the algorithm tries to switch the inner segments from flight to landing (thus merging two adjacent turnings) one-by-one. This is applied for segments that are shorter than 3× the stair width; if there are at least 3 segments in a stair and the turning types are winders with equal goings and they are unidirectional turnings (all turnings are clockwise, or all turnings are counterclockwise), the algorithm tries to switch the inner segments from flight segment to winder segment (thus merging two adjacent turnings) one-by-one. This is applied for segments that are shorter than 3× the stair width; offset the walking line of the stair within a range permitted by the standard; select a different winder type; adjust the length of the first segment of the polyline; offset the walking line of the stair and adjust the length of the first segment of the polyline; and select a different winder type and adjust the length of the first segment of the polyline.

In yet another aspect, the system is configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of: iteratively adjust total number of steps; iteratively adjust the length of the first segment of the polyline and the total number of steps; iteratively adjust length of every other segment of the polyline one by one (only one segment at a time); and iteratively adjust length of every other segment one by one and the length of the first segment of the polyline.

In one more aspect, the system is configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of: iteratively change the turning type for the first winder turning to symmetrical landing and if this does not provide a result, the following ones, one by one (symmetrical landing is a landing where lead and trail edge offsets are equal); iteratively change the turning type for the first winder turning to non-symmetrical landing turning type and if this does not provide a result, the following ones, one by one (non-symmetrical landing is a landing where lead and trail edge offsets are not equal); iteratively adjust the length of the first segment of the polyline and change the turning type one by one from winder turning to non-symmetrical landing; change the turning type for all turnings to symmetrical landing; change the turning type for all turning to non-symmetrical landing and change any winder (with equal angles or with equal goings) segment types to run segments; mark all segments as flexible; and change the turning type for all turning to non-symmetrical landing and change any winder segment types to run segments and adjust the length of all segments.

In yet another aspect, the system is configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of: if there are at least 3 segments in a stair and the turning types are landings, then the algorithm tries to switch the inner segments from flight to landing (thus merging two adjacent turnings) one-by-one. This is applied for segments that are shorter than 3× the stair width; if there are at least 3 segments in a stair and the turning types are winders with equal goings and they are unidirectional turnings (all turnings are clockwise, or all turnings are counterclockwise), then the algorithm tries to switch the inner segments from flight segment to winder segment (thus merging two adjacent turnings) one-by-one. This is applied for segments that are shorter than 3× the stair width; offset the walking line of the stair within allowed range; select a winding turning from a group of pre-stored winding turnings; adjust the length of the first segment of the polyline; offset the walking line of the stair and adjust the length of the first segment of the polyline; select a different winder type and adjust the length of the first segment of the polyline; iteratively adjust total number of steps; iteratively adjust the length of the first segment and the total number of steps; iteratively adjust length of every other segment one by one; iteratively adjust length of every other segment and the length of the first segment; iteratively change the turning type for the first winder turning to symmetrical landing turning type and if this does not provide a result, the following ones, one by one; iteratively change the turning type for the first winder turn to non-symmetrical landing turning type and if this does not provide a result, the following ones, one by one; iteratively adjust the length of the first segment of the polyline and change the turning type one by one from winder turning to non-symmetrical landing; change the turning type for all turnings to symmetrical landing; change the turning type for all turning to non-symmetrical landing and change all winder segments to run segments; mark all segments as flexible; and change the turning type for all turning to non-symmetrical landing and change any winder segment types to run segments and adjust the length of all segments.

### BRIEF DESCRIPTION OF DRAWINGS

FIGS. 1A and 1B depict a graphical user interface of stair controller algorithm, in accordance with certain example embodiments.

FIG. 2 depicts a diagram of a stair having goings, treads, and risers, in accordance with certain example embodiments.

FIG. 3 depicts a block diagram of the stair controller algorithm in accordance with certain example embodiments.

FIGS. 4A and 4B depict a block diagram of the stair variation logic process, in accordance with certain example embodiments.

FIG. 5 depicts a block diagram of the stair constructor process, in accordance with certain example embodiments.

FIG. 6 depicts an example of the offset values and the start and endpoints of walking line sections, in accordance with certain example embodiments.

FIG. 7 depicts an example stair where the turning types are winders with equal goings and unidirectional turnings, in accordance with certain example embodiments.

FIG. 8 depicts an example of a number of stair solutions generated by the stair control algorithm, in accordance with certain example embodiments.

FIG. 9 depicts an example staircase with symmetrical landing and non-symmetrical landing, in accordance with certain example embodiments.

FIG. 10 depicts a computing machine and a system applications module in accordance with example embodiments.

### DETAILED DESCRIPTION OF THE EXAMPLE EMBODIMENTS

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not delimit the scope of the present invention.

The example embodiments presented herein are directed to systems, methods, and computer program products for a stair controller algorithm that assists an architect when architect entered stair design data results in a stair design that doesn't meet standard requirements, e.g. standardized requirements defined by a community, city, state or federal body, or any combination thereof. The stair controller algorithm produces an alternative design with as little modification of the original design as possible and additionally an alternative design or designs that include a greater degree of modification needed to satisfy a set standardized system. In practice, the architect can set or modify standard values, design constraints, and geometric polyline values in a dialog box. The stair controller algorithm can continuously run in the background trying to determine the best matching stair layout for the current configuration. The stair controller algorithm determines many alternative design configurations by modifying one or all the design constraints and geometry, as well as standard values, in order to find a working layout. Based on the possible alternatives, the user is provided with live feedback of alternative designs that adhere to a country's traditional practices and standards. The architect can then pick from the choices provided and the stair layout can be created accordingly.

The stair controller algorithm comprises a stair constructor process and a stair variation logic process. The stair constructor process creates a stair layout based on the configuration allowing limited changes to the constraints. The stair constructor process attempts to solve compliance issues, using minimal design changes where possible. If a solution can be found, an alternative stair configuration is returned. If not, the stair variation logic process is called and a more extensive reconstruction of the original design is performed in order to find at least one satisfactory configuration. The configurations can be weighted according to the ones that adhere to the standard requirements with as few modifications to the original design as possible. In addition to validating and weighing the results returned from the stair variation logic process, the stair constructor process may re-execute and re-modify certain configurations parameters based on results of the variation logic process.

Referring now to the drawings, in which like numerals represent like (but not necessarily identical) elements in the different figures, example embodiments are described in detail.

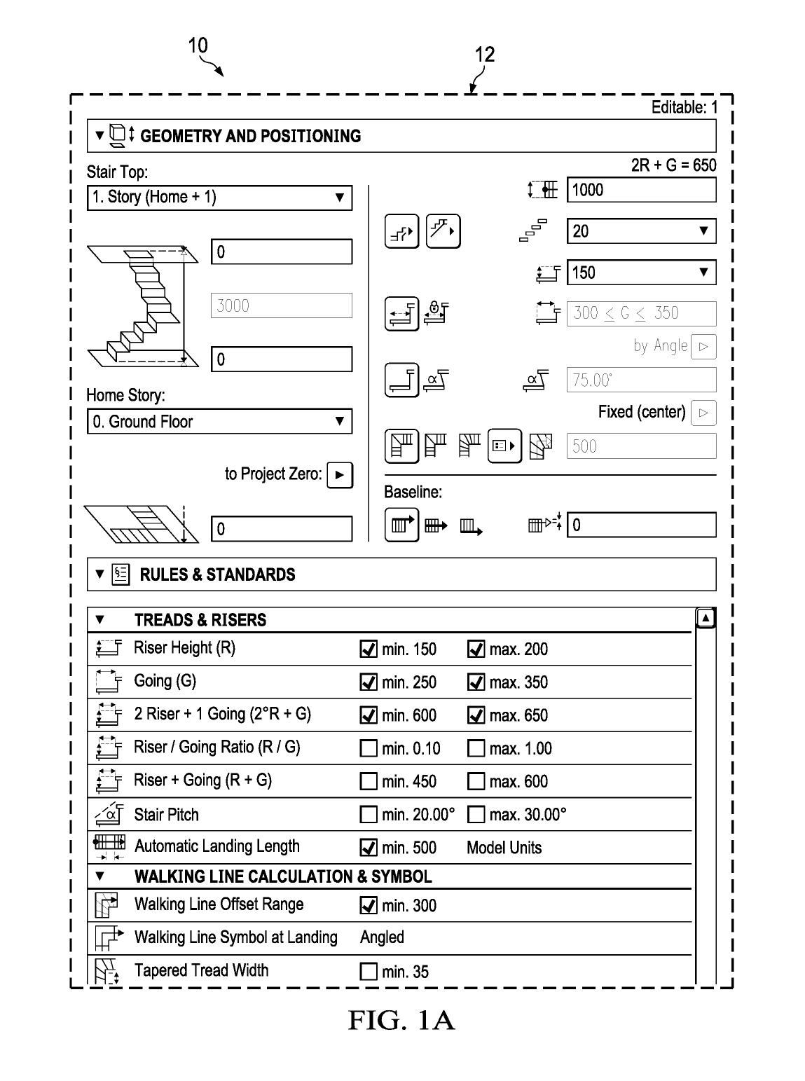

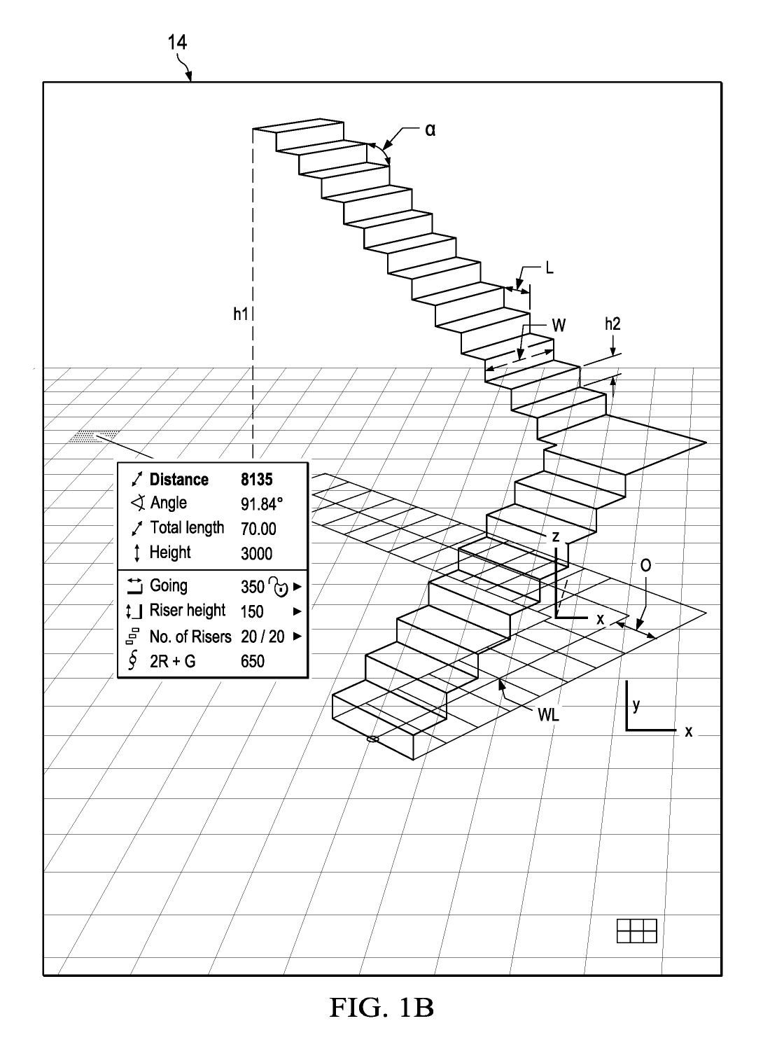

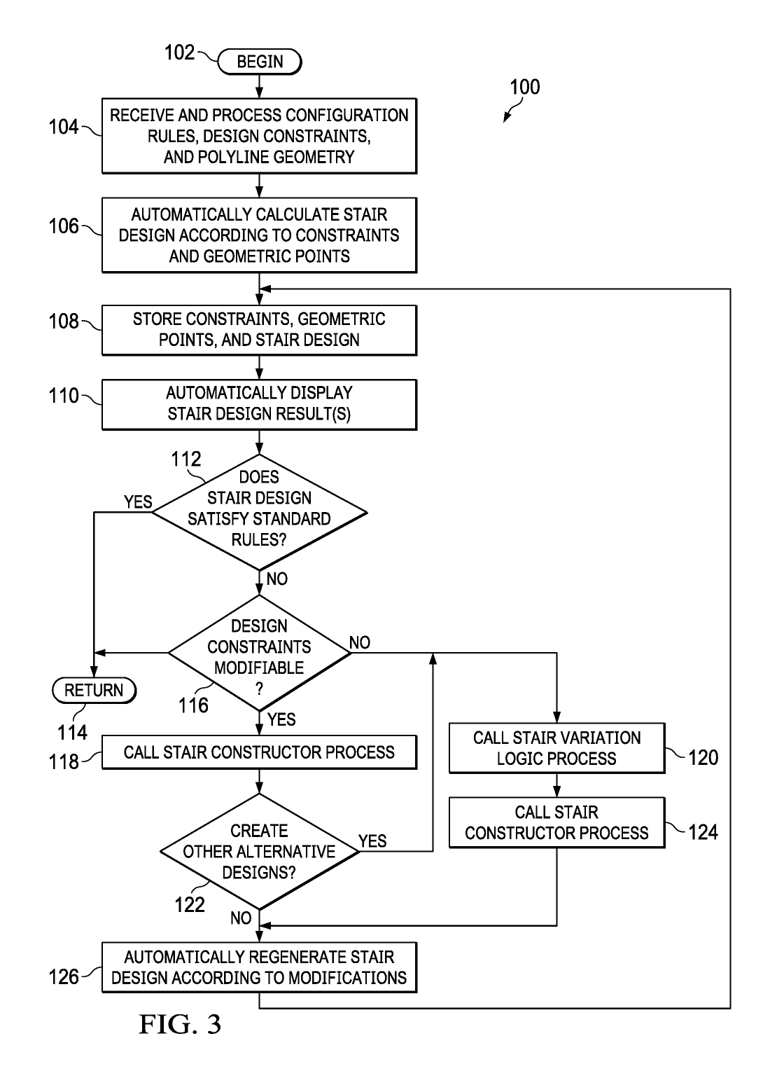

FIG. 1 is a graphical user interface of a stair controller algorithm in accordance with certain example embodiments denoted generally as 10. The interface 10 includes a form entry box 12 and a user definable and automatically generatable stair design 14, automatically generatable pursuant to the process logic of a stair controller algorithm discussed in more detail with respect to FIGS. 3-5. Form entry box 12 can include geometry and positioning data for stair structure components. For example, the values entered here can define the stairs height h1, the width w of the stair, height h2 of the risers 16, the depth L of the goings 18, the sum of the riser multiplied by two and the going, the number of steps, or alternatively the number of treads, whether the stairs start and end with riser 16 or goings 18, a walking line 20 of the stair, a walking line offset O, and the stair pitch a. Form entry box 12 further includes standards and general rules for the design of stair structural components that process logic used to generate the stair design so that the result adheres to required standards. An example of these rules and standards are defined in table 1 below.

| Stair Layout | |
|---|---|
| Configuration | Standard Dimensions Parameters |
| Goings | Minimum-Maximum Length Range |
| Risers | Minimum-Maximum Height Range |
| Riser/Going Ratio | Minimum-Maximum Ratio Range |
| Riser + Going | Minimum-Maximum Length Sum Range |
| Stair Pitch | Minimum-Maximum Angle Range |
| 2 * Riser + Going | Minimum-Maximum Length Range |
| Walking Line - | Minimum Length |
| Landing | |
| Walking Line - | Minimum Offset |
| Stair's Edge | |
| Winding Step | Minimum Inner Width |

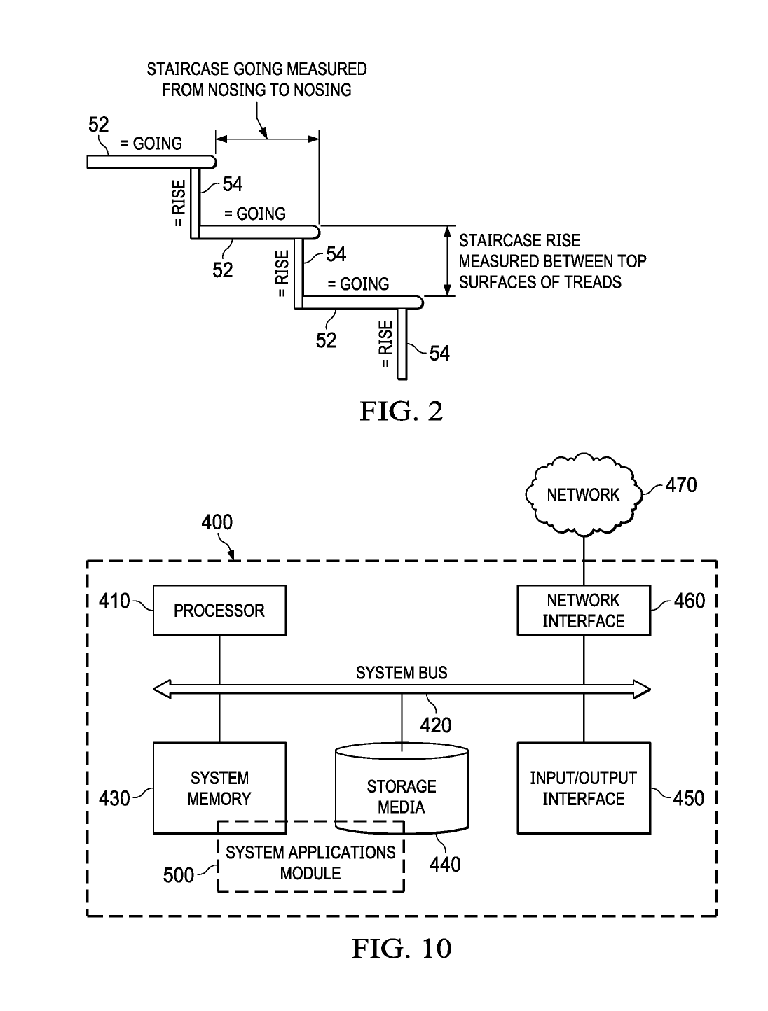

Stair design 14 can be controlled based on rules published by a country's authorities (e.g., federal, state, or local rules), and constraints and geometry created by the architect. Although the standard values can be changed by the user, the alternative designs are generated according to the strict requirements of a set of standard values. Reference can be made to FIG. 2 to better demonstrate more clearly some of the terminology used in reference to FIG. 1 and table 1. FIG. 2 is a diagram of a stair that better illustrates the meaning of a going, treads, and risers and is denoted generally as 50. The diagram 50 includes three treads 52 and three risers 54 and a measurement for the going as measured from nosing to nosing and the staircase rise as measured between top surfaces of the treads. As illustrated in table 1, the riser height, the going width, the 2 times riser plus going, the riser+going, the riser/going ratio, and the stair pitch are stair components or designs governed by a minimum and maximum range values. Other regulated components include the automatic landing length, the walking line offset range, the walking line symbol at landing, and the tapered tread minimal width which also include definable ranges and values. The values can be set, for example, by the user of the system or can be preset at manufacture and depending on the country of use the rules and regulations could be preloaded during execution.

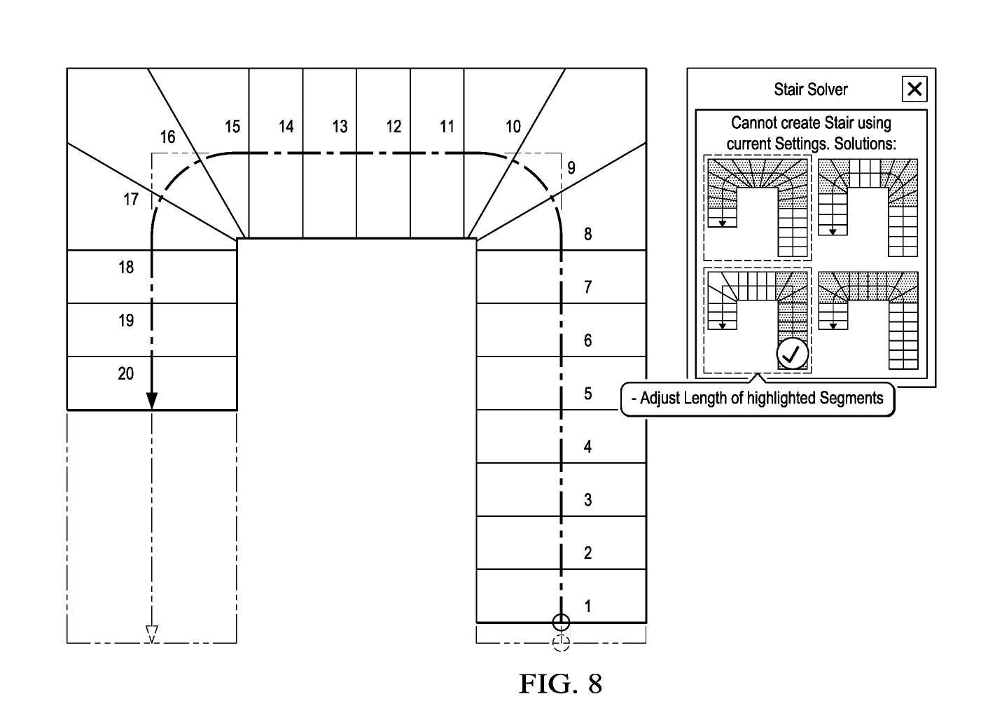

FIG. 3 is a block diagram of the stair controller algorithm in accordance with certain example embodiments denoted generally as 100. The algorithm 100 begins at block 102 where, upon execution, the algorithm receives and processes design constraints and polyline geometry, and a standard rule set for a country, state, city, or other type of region in real-time, block 104, i.e. as the values are being entered. Although, it should be understood, the standard rule set includes parametric values that can be changed or modified by the user there always exists a static copy. At block 106, a stair design can be automatically calculated as data is being processed. At block 108, the stair design constraints, geometric points, and stair design can be stored, e.g. as in line session data. At this point, the stair design can be automatically displayed, block 110, in real time, i.e. as the user is entering information. If algorithm 100 cannot find a solution with the start boundary conditions during the polyline input, it will offer alternative solutions, see FIG. 8, at the end of the input. At block 112, the algorithm determines if the stair design satisfies standard rules. If the stair design does satisfy the rules, the algorithm returns to the calling process, block 114. If the stair design does not satisfy the rules, it is determined whether the design constraints are modifiable, block 116. If it is determined that the design constraints are modifiable, a stair constructor algorithm is called to modify the constraints at block 118. If, however, the design constraints cannot be modified, a variation logic algorithm is called at block 120. In the event the design constraints are modified, it can be further determined if other alternative designs should be generated, at block 122. If other alternatives are needed, the stair variation logic algorithm is called at block 120. Where upon completion of the variation logic algorithm, the stair constructor algorithm can be called again at block 124. Once the alternative stair design or designs are generated by the stair constructor algorithm or the stair constructor algorithm and the variation logic algorithm, the stair design can be automatically recalculated according to the modified parameters at block, 126. The new results can then be stored and automatically displayed to the architect. Although algorithm 100 is shown as a flowchart, a person off skill in the art would recognize that a state diagram, object oriented, or other types of programming could be used.

Stair design and construction in architecture are limited by a set of regulations that differ in every country. These local standards strive for the same goal to design a Stair that is safe and comfortable to walk on, without the danger of tripping, and in certain cases, also help creating an aesthetically pleasing structure support (winder stairs mostly).

These rules usually:
control the height/length ranges of a Stair Risers/Treads
in some form provide limits for the Stair pitch as well (e.g. limit riser/going ratio, Riser+Going sum, or another form of simple equation that links these values together)
drive minimum widths and lengths of landings
provide detailed construction instructions for the different type of Stairs

In conventional pen-and-paper architectural design, in 2D CAD design, or even in contemporary BIM solutions, adhering to these Rules is an iterative process, carried out manually by the architects themselves. They can choose whichever dimensions they want, the design tool (e.g. BIM software) does not prove their work, nor does it help in following the regulations, neither does it prevent unsafe, or even non-constructible Stair designs.

The solution aims to aid the Users/Architects in designing stairs that meet the local regulations. For this, algorithm uses three main components:

I. A Set of Customizable Construction Rules

These Rules provide the constraints, and describe local regulations for Stairs. They can be preset by the User/BIM manager—differently country by country. Then the User can choose those Rules that apply to that specific project, or even by individual Stairs, and set the allowed ranges.

Possible Rules include:
min/max length range for Goings
min/max height range for Risers
min/max range for Riser/Going ratio (US)
min/max length range for Riser+Going Sum (US)
min/max angle range for Stair Pitch (US)
min/max length range for 2*Riser+Going Sum (EU)
min Walking Line length for Landings
min offset of the Walking Line from the Stair's edge
min width of a winder step

II. An Automatic Stair Construction Algorithm

Inputs from the Users:
required total Stair height
required total number of Steps
required Stair width
required Walking Line offset (mainly at winder Stair)
turning types (landing, winder with equal angles or winder with equal goings)
segment types during input (run, landing, winder with equal angles or winder with equal goings)
and a polyline path which the Stair should follow

Based on these inputs and the set of Rules, it constructs a Stair.

To perfectly follow the polyline path defined by the User, the algorithm automatically adjusts certain geometric values of the stair, within the ranges provided by the Rules:
going depth
automatic landing length
lead and trail offsets are calculated automatically (within regulations)
for segments of the polyline marked as “flexible”, it can also adjust the segment length, while keeping the segment directions intact (e.g. for a U-shaped stair, adjusting the second segment length would make the entire stair narrower)
   the User cannot directly mark segments as “flexible”
   this is only used by the algorithm described in III. to adjust segment lengths if needed

The Walking Line position—even if it has side offset set by default—is always fix during construction of a Stair.

During the polyline path input, instant graphical feedback shows what the resulting stair can look like.

III. A Graphical Interface with Automatic Solutions to Resolve Conflicts

In some cases, the input values and the polyline path provided by the User cannot result in an adequate Stair, however there are certain possible geometric modifications, that could create a Stair that follows the set Rules.

These “solvable” cases have a distinct, instant graphical feedback during the polyline path input. The process is the following:
the solvable state is determined, whenever the algorithm (described in II.) reports the Stair as “invalid”—e.g. impossible to construct following all the Rules
in such cases, the algorithm generates another, modified Stair in the background using the last strategy in its list
if that results in a valid stair, there exists at least one solution to the User's input, so the input polyline is deemed “solvable”
if even that strategy fails, (being the most flexible of all strategies implemented), only then is the input polyline deemed completely “invalid”, which results in the User not being able to finish their input at that specific point

If the User decides to finish the polyline in a “solvable” state, the algorithm generates possible solutions to choose from:
these solutions make slight modifications to the original geometry defined by the User,
while keeping the set of Rules intact,
and making sure that the offered solutions do meet the regulations
the generated solutions are presented to the User on a visual interface, indicating for each solution what changes have been made
the User can select any of the offered alternative solution, and see instant graphical feedback in the plan of how the modified stair would look like in its building context, before accepting that very alternative

The solutions are generated using an algorithm, that:
changes a few of the geometric parameters set by the User
tries to generate a Stair using the modified input parameters, and the construction algorithm described in section II. above
if the modified Stair can be created according to the Rules,
adds it as a solution to the list
generates a preview image that highlights the changes made (in the Turning type or Segment type or the position of the Walking Line)
also, generates a text description that describe the changes made
and repeats steps above until either there are no further options it can try, or a certain number of possible solutions have already been found

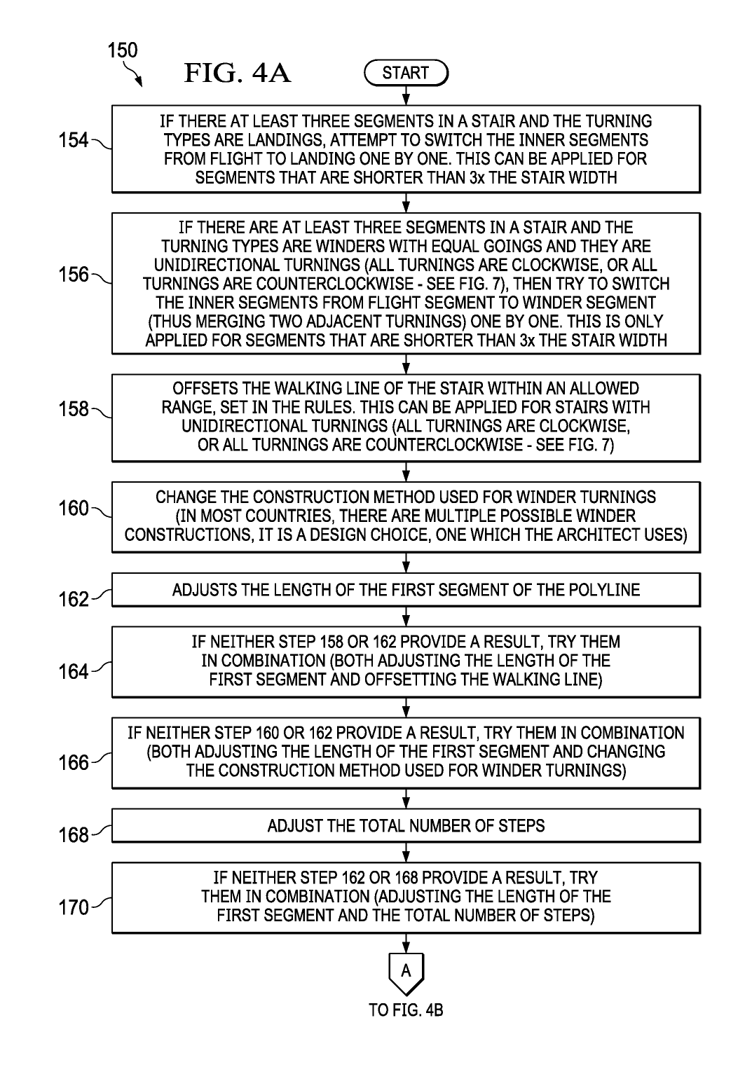

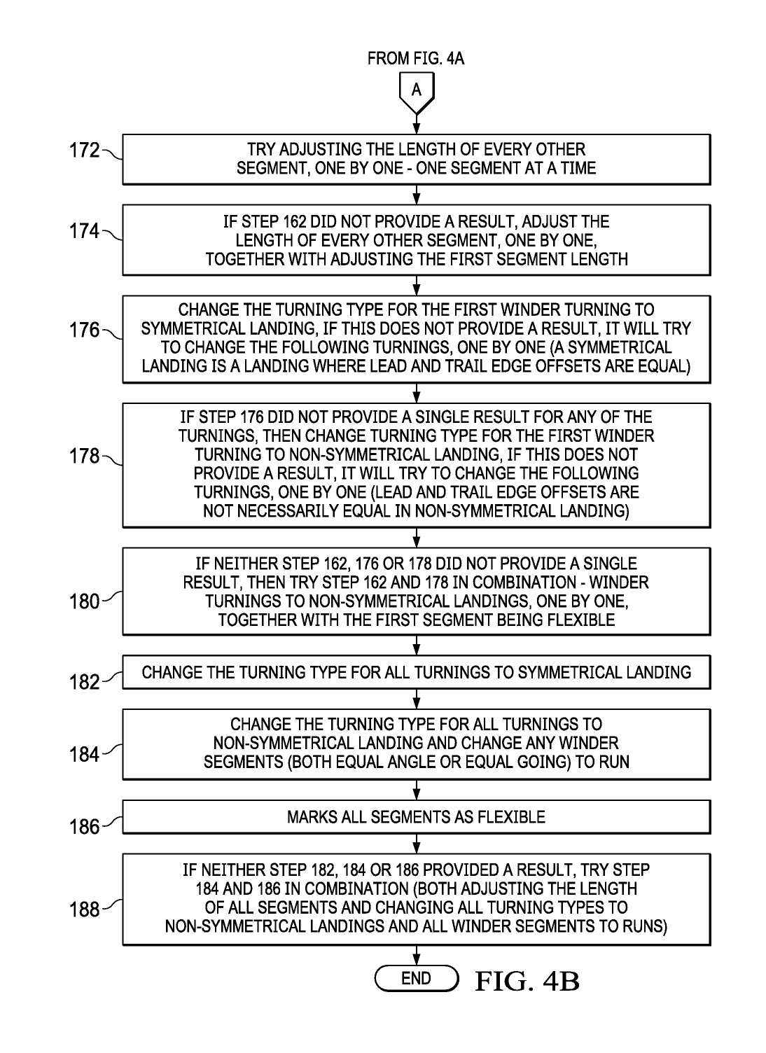

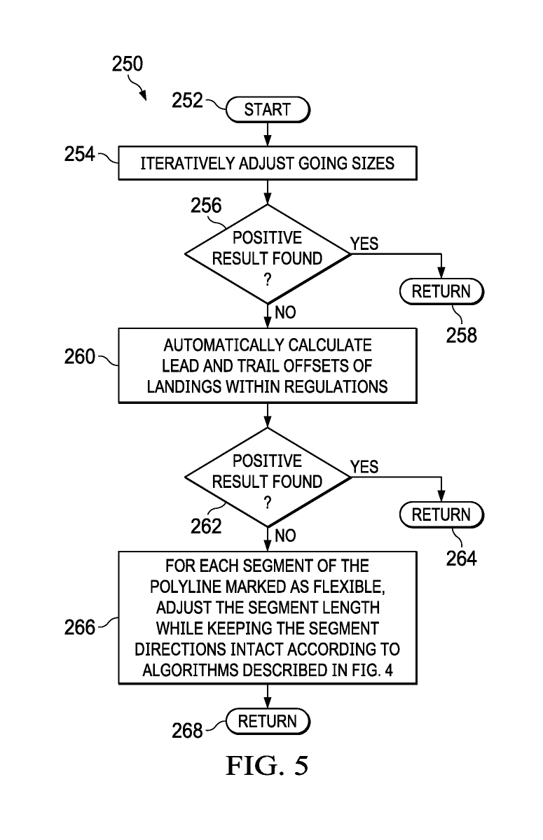

FIGS. 4A and 4B are block diagrams of the stair variation algorithm, according to an embodiment, denoted generally as 150. The algorithm 150 tries the list of geometric modifications (strategies) in a specific order, as follows:

1. If there are at least 3 segments in a stair and the turning types are landings, then tries to switch the inner segments from flight to landing (thus merging two adjacent turnings) one-by-one. This is only applied for segments that are shorter than 3× the stair width, see block 154;

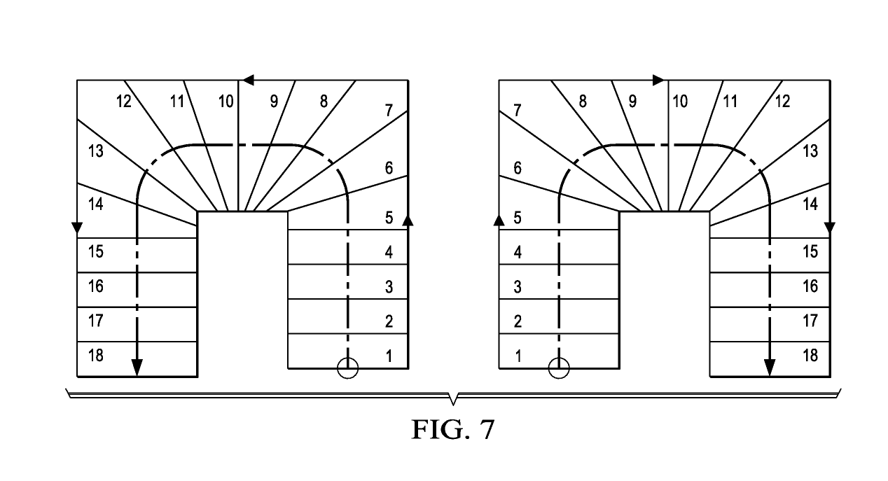

2. if there are at least 3 segments in a stair and the turning types are winders with equal goings and they are unidirectional turnings (all turnings are clockwise, or all turnings are counterclockwise—see FIG. 7), then tries to switch the inner segments from flight segment to winder segment (thus merging two adjacent turnings) one-by-one. This is only applied for segments that are shorter than 3× the stair width, see block 156;

3. offsets the Walking Line of the Stair within an allowed range, set in the Rules. This can be only applied for stairs with unidirectional turnings (all turnings are clockwise, or all turnings are counterclockwise—see FIG. 7), see block 158;

4. changes the construction method used for winder turnings (in most countries, there are multiple possible winder constructions, it is a design choice which one the architect uses), see block 160;

5. adjusts the length of the first segment of the polyline, see block 162;

6. if neither step 3 or 5 provided a result, tries them in combination (both adjusting the length of the first segment and offsetting the walking line), see 164;

7. if neither step 4 or 5 provided a result, tries them in combination (both adjusting the length of the first segment and changes the construction method used for winder turnings), see block 166;

8. adjusts the total number of steps, see block 168;

9. if neither step 5 or 8 did not provide a result, tries them in combination (adjusting the length of the first segment and the total number of steps), see block 170;

10. tries adjusting the length of every other segment, one by one only one segment at a time, see block 172;

11. if step 5 did not provide a result, tries adjusting the length of every other segment, one by one, together with adjusting the first segment length, see block 174;

12. changes the Turning type for the first winder turning to Symmetrical Landing, if this does not provide a result, it can try to change the following turnings, one by one (a Symmetrical Landing is a landing where Lead and Trail edge offsets are equal), see block 176;

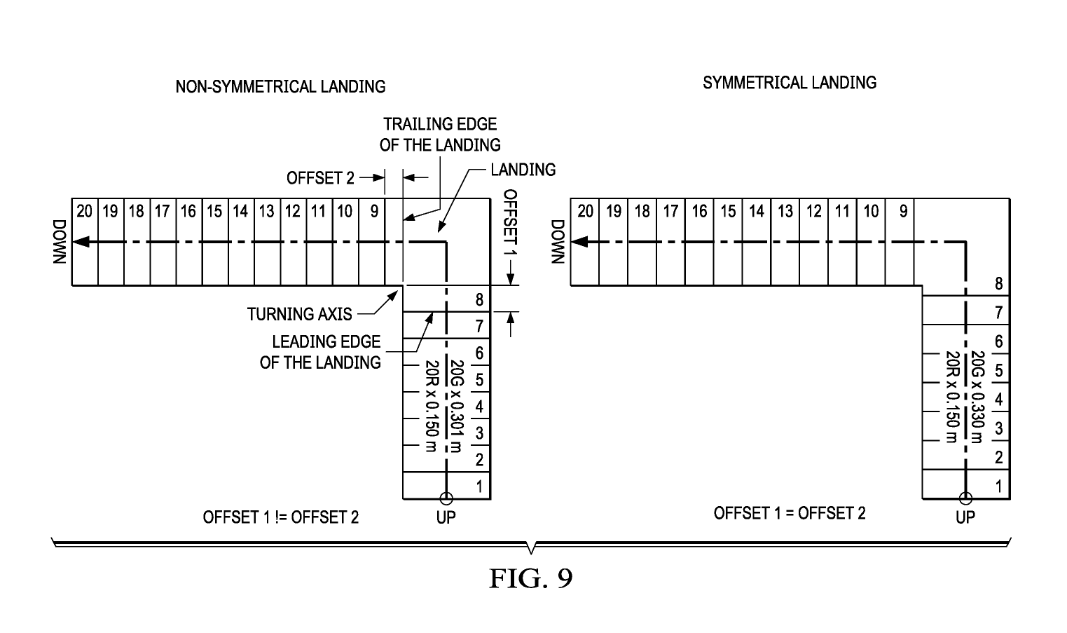

13. if step 12 did not provide a single result for any of the turnings, then changes turning type for the first winder turning to Non-Symmetrical Landing, if this does not provide a result, it can try to change the following turnings, one by one (Lead and Trail edge offsets are not necessarily equal in Non-Symmetrical Landing—see FIG. 9), see block 178;

14. if neither step 5, 12 or 13 did not provide a single result, then tries step 5 and 13 in combination winder turnings to Non-Symmetrical Landings, one by one, together with the first segment being flexible, see block 180;

15. changes the turning type for all turnings to Symmetrical Landing, see block 182;

16. changes the turning type for all turnings to Non-Symmetrical Landing and changes any winder segments (both Equal Angle or Equal Going) to Run, see block 184;

17. marks all segments as flexible, see block 186; and

18. if neither step 15, 16 or 17 provided a result, tries step 16 and 17 in combination (both adjusting the length of all segments and changing all turning types to non-symmetrical landings and all winder segments to runs), see block 188.

The order of strategies is set to increase from the least amount of change made to the originally requested polyline path to the largest modification so the User is always presented with those solutions first that require minimal change to the original design intent. For each step, if the algorithm finds a solution, proceeds to the next step. So, one step can never give more than one solution. This process goes on, until it can find 4 solutions or until it goes through all the steps. Then, these solutions are displayed graphically on the interface with text description. (see FIG. 8). The number of solutions currently displayed is 4, but it could even be expandable. During the design, the 4 options are sufficient for the user to find the most appropriate solution.

The behavior is implemented both when drawing a Stair from scratch, and whenever User modifies an existing Stair:
if the Stair remains valid after the modification, the input is accepted without question; and
if the Stair becomes invalid, but still is deemed solvable after a modification, the same graphical interface follows the modification made, providing a possible tradeoff for making the modification by adjusting some other geometric aspect of the Stair in return.

During non-graphical editing of the Stair (e.g. dialog-based interactions), after each modification made in the dialog, the same evaluation is run. If the software can tell that the Stair can become solvable after the User presses the OK button, a warning sign comes up indicating that the current values can require geometric changes. This allows the Users to fix those values themselves, or accept the help of the algorithm described herein by pressing OK, and facing the same graphical solution-selection interface described before.

FIG. 5 is a block diagram of the stair constructor algorithm in accordance with certain example embodiments denoted generally as 250. The algorithm 250 begins at block 252 upon being called and continues at block 254 by iteratively adjusting going sizes by preset numerical range until a result or positive results can be found or can otherwise be determined that no such result exists, as determined by block 256. If a positive result or results are found, the results can be returned, block 258, or if no result or results can be found the algorithm continues by automatically adjusting lead and trail offset within the defined standards, block 260 until a positive result or results can be found or until it is determined that no result exists, as determined in block 262. If a positive result can be found, the algorithm 250 returns the results in block 264 or otherwise the algorithm 250 continues by adjusting the segment length while keeping the segment directions intact for each segment marked as flexible, block 266. Results can be returned at block 268. It should also be understood that the logic of validating a result or results could be performed once or so and a result or results returned for use. Although algorithm 250 is shown as a flowchart, a person off skill in the art would recognize that a state diagram, object oriented, or other types of programming could be used.

Simplex Method—The usage of the Simplex Method in the algorithm. The stairs are created by considering a complex set of rules. Some parameters of a stair corresponding to the rules and standards—may vary during schema generation, while others remain constants. Based on the set rules, different conditions for these parameters in the form of inequalities and equations can be formulated. Furthermore, all the variable parameters can be greater than or equal to 0, When generating a schema, the optimal value of a linear objective function with variables can be found. This is a linear programming task that is solved using the Simplex Algorithm.

In this linear programming task, the following parameters will be variables, all of which are fulfilled to be non-negative (i=1 . . . {inputPolyline.EdgeNum}, with i representing index): treadDepth: the value of the Tread Depth. offsetᵢ₁ and offsetᵢ₂:

If in the i^{th} turning is in an automatic landing:
the offsetᵢ₁ will contain the distance between the leading edge of the landing and the first
turning line of the landing, measured on the internal side of the turning
the offsetᵢ₂ will contain the distance between the trailing edge of the landing and the second turning line of the landing, measured on the internal side of the turning

If the i^{th} turning is a winder turn with tapered treads, then offsetᵢ₁=offsetᵢ₂=0.

If the i^{th} input segment is a landing segment, then offsetᵢ₂=offset₍ᵢ₊₁₎₁=0. wPartLengthᵢ: Each input segment includes a walking line segment length. The walking line segment is a polyline that is cut from the walking line. The walking line segments are defined as follows:
If there is an automatic landing turn at e start point of the input segment, the beginning of the walking line segment will be the same as the intersection of the walking line and the second turning point of the automatic landing which is at the start point of the input line.
If there is a winder turn with tapered steps at the start point of the input line, then the starting point of the walking line segment is the same as the intersection of the walking line and the axis of the turning point which is at the start point of the input line.
The end point of the walking line is calculated as above: in this case, consider the turning point at the end point of the current input segment, as well as the first turning line at this turning point.
The starting point of the walking line segment for the first input segment is the same as the starting point of the walking line.
   The end point of the walking line segment for the last input segment is the same as the end point of the walking line.

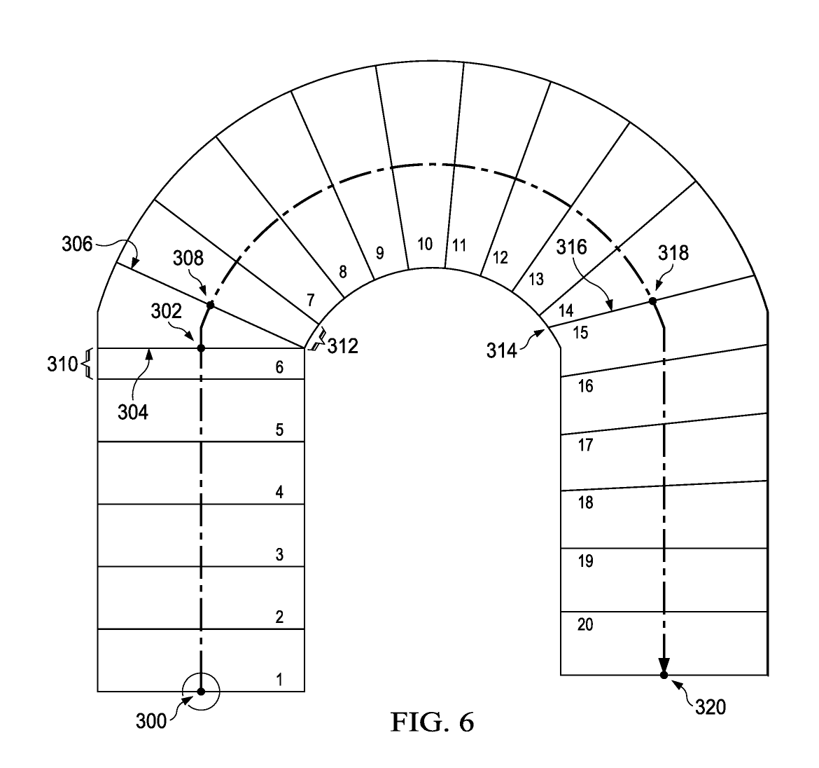

FIG. 6 shows an example of the offset values and the start and endpoints of the walking line sections: 300 is starting point of the walking line segment No1; 302 is the end point of the walking line segment No1; 304 is the first turning line; 306 is the starting point of the walking line segment No2; 308 is the second turning line; 310 is offset₁₁; 312 is offset₁₂; 314 is offset₂₁ which equals offset₂₂=0; 316 is the turning axis; 318 is the end point of the walking line segment No2 and starting point of the walking line segment No3; and 320 is the end point of the walking line segment No3.

The parameters listed below remain constants during the schema generation (i=1 . . . {inputPolyline.EdgeNum}):

isTreadDepthLocked: the fixed status of the value of the going depth
treadDepthConst: the fixed value of the going (it only applies for fixed going value)
treadRealMin: the minimal value of the going (it only applies when variable going value is set)
treadRealMax: the maximal e of the going (it only applies when variable going value is set)
minOffsetᵢ: the minimum offset value for all turnings
isSegmentLockedᵢ: status of the lock for all segments
isSymOffsetᵢ: symmetry (i.e. equality) value of the offset for all turnings
isOffsetLockedᵢ: fixed value of the offset for all turnings
stepNumᵢ: contains the number of created steps for all walking line segments
wPartLengthConstᵢ: the fixed length of the walking line segments
isLandingSegmentᵢ: contains if the segment is a landing segment or not, for all input segments
isLandingTurnᵢ: contains if it is a landing or not, for all turnings
atLandingEndᵢ: contains if there is an end of a landing at the turning or not for all turnings
startNodeIndexOfLandingᵢ: the start point index of the last landing before the i^{th} segment
endNodeIndexrOfLandingᵢ: the end point index of the last landing before the i^{th} segment
minLandingLength: the minimum length of a landing
isMaximization: indicates the algorithm is looking for a maximum or minimum value
segmentRadiusRatioᵢ₁ and segmentRadiusRatioᵢ₂: the offsetᵢ₁ and offsetᵢ₂ values are always measured on the internal side of the stair's i^{th} turning, but inequalities and equations require offset values that are measured on the walking line.
The segmentRadiusRatioᵢ₁ gives the ratio of the radius of the walking line segment before the turning point and the radius of the stair inner side on the same segment, in case of curved geometry.
Similarly, the segmentRadiusRatioᵢ₂ contains the ratio of the radiuses of curved segments after the turning point.
For straight segments, their value is: 1
turningEdgePosᵢ₁: the distance from the intersection of the walking line and the first turning line of the i^{th} turn to the starting point of the walking line, measured on the walking line
turningEdgePosᵢ₂: the distance from the intersection of the walking line and the second turning line of the i^{th} turn to the starting point of the walking line, measured on the walking line

The conditions of our linear programming task can be given in the form of inequalities and equations (i=1 . . . {inputPolyline.EdgeNum}):
Restriction for fixed going:
   isTreadDepthLocked=>
      treadDepth=treadDepthConst [symbol]
Restriction for variable going within a range:
   !isTreadDepthLocked=>
      treadDepth>=treadRealMin && [symbol]
      treadDepth<=treadRealMax [symbol]
The offset values for the first vertex of the input line is 0:
   i==1=>
   offsetᵢ₁=0 && [symbol]
   offsetᵢ₂=0 [symbol]
The offset values for the winder turnings are:
   i<inputPolyline.EdgeNum=>
      !isLandingTurnᵢ₊₁=>
         offset₍ᵢ₊₁₎₁=0 && [symbol]
         offset₍ᵢ₊₁₎₂=0 [symbol]
in a landing segment, the offset value of a landing turn's trailing edge and leading edge are equal to 0:
   isLandingSegmentᵢ=>
      offsetᵢ₂=0 && [symbol]
      offset₍ᵢ₊₁₎₁=0 [symbol]
Restriction for landings with fixed offset:
   i<inputPolyline.EdgeNum=>
      atLandingEndᵢ₊₁ && isOffsetLocked_{starNodeIndexOfLandingi+1}=>
         offset_{startNodeIndexOfLandingi+11}=minOffset_{startNodeIndexOfLandingi+l} [symbol]
      atLandingEndᵢ₊₁ && isOffsetLocked_{endNodeIndexOfLandingi+1}=>
         offset_{endNodeIndexOfLandingi+12}=minOffset_{endNodeIndexOfLandingi+1} [symbol]
Restrictions for symmetrical landing:
   i<inputPolyline.EdgeNum=>
      atLandingEndᵢ₊₁ && (isSymOffset_{startNodeIndexOfLandingi+1}∥
      isSymOffset_{endNodeIndexOfLandingi+1})=>
         offset_{startNodeIndexOfLanding(i+1)1}−offset_{endNodeIndexOfLandingi+12}=0 [symbol]
If the offset of a landing is not fixed, it may vary within a range:
   i<inputPolyline.EdgeNum=>
      atLandingEnd₍ᵢ₊₁₎&& !isOffsetLocked_{startNodeIndexOfLandingi+1}=>
         offset_{startNodeIndexOfLandingi+11}>=minOffset_{startNodeIndexOfLandingi+1} && [symbol]
         offset_{startNodeIndexOfLandingi+11}−treadDepth<=
         minOffset_{startNodeIndexOfLandingi+1} [symbol]
      atLandingEnd₍ᵢ₊₁₎ && !isOffsetLocked_{endNodeIndexOfLandingi+1}=>
         offset_{endNodeIndexOfLandingi+12}>=minOffset_{endNodeIndexOfLandingi+1} && [symbol]
         offset_{endNodeIndexOfLandingi+12}−treadDepth<=
         minOffset_{endNodeIndexOfLandingi+1} [symbol]
Restriction for a length of a landing:
   i<inputPolyline.EdgeNum=>
      atLandingEnd₍ᵢ₊₁₎=>
         segmentRadiusRatio_{startNodeIndexOfLandingi+11}*offset_{startNodeIndexOfLandingi+11}+
         segmentRadiusRatio_{endNodeIndexOfLandingi+12}*offset_{endNodeIndexOfLandingi+12}>=
         minLandingLength+
         turningEdgePos_{starNodeIndexOfLandingi+11}
         turningEdgePos_{endNodeIndexOfLandingi+12} [symbol]
In case of fixed input segment, the associated walking line will be fixed as well:
   (i<inputPolyline.EdgeNum ∥ isMaximization) && isSegmentLockedᵢ=>
      wPartLengthᵢ=wPartLengthConstᵢ [symbol]
In case of non-fixed input segment, the length of the associated walking line section may vary within a radius of one going depth:
   (i<inputPolyline.EdgeNum ∥ isMaximization) && !isSegmentLockedᵢ=>
      treadDepth+wPartLengthᵢ>=wPartLengthConstᵢ && [symbol]
      wPatLengthᵢ−treadDepth<=wPartLengthConstᵢ [symbol]
Restriction for the sum of the goings and offset values for one walking line segment, in a flight segment:
   (i<inputPolyline.EdgeNum ∥ isMaximization) && !isLandingSegmentᵢ=>
      i<referencePolyline.EdgeNum=>
         stepNumᵢ*treadDepth+segmentRadiusRatioᵢ₂*offsetᵢ₂+
         segmentRadiusRatio₍ᵢ₊₁₎₁*offset₍ᵢ₊₁₎₁−wPartLengthᵢ=0 [symbol]
      i==inputPolyline.EdgeNum && isMaximization=>
         stepNumᵢ*treadDepth+segmentRadiusRatioᵢ₂*offsetᵢ₂<=
         wPartLengthConstᵢ

[symbol]

The Objective Function:

Let F be the objective function and n=inputPolyline.EdgeNum
Until input doesn't reach the specified height of the stair, the wing must be minimized:
F (treadDepth, offset₁₁, . . . , offsetₙ₂, wPartLength₁, . . . wPartLengthₙ)=−treadDepth
Once input reached the specified height of the stair, the sum of the going and the offset value of the trailing edge in the last turning needs to be maximized
F (treadDepth, offset₁₁, . . . , offsetₙ₂, wPartLength₁, . . . , wPartLengthₙ)=treadDepth+offsetₙ₂

The implementation of the Simplex algorithm: The stepNumᵢ constants in inequalities and equations should in fact be variables, but for all input segments, only a few possible integer values would be possible. For the sake of simplicity, our linear programming task may only contain real-type variables, so stepNumᵢ are considered constant and the algorithm creates multiple linear programming tasks differ only in the values of stepNumᵢ constants. For each i, the lowest possible value for stepNumᵢ is the floor(wPartLengthConstᵢ/treadRealMax), and the maximum possible value is ceil(wPartLengthConstᵢ/treadRealMin). For each i, the algorithm takes any possible value of stepNumᵢ, so the algorithm can get a variation for the number of steps of the input segments. Thus, all possible variations are created. Each variation defines a linear programming task, in which the simplex algorithm is ran until a solution is found and until all the tasks are gone through. Based on the optimum solution calculated from the variables, the desired stair can be constructed.

In addition to the algorithm above or in the alternative, the stair tool algorithm can work from 3 input sources of information: #1 local standards (a number of preset rules providing the ergonomics of the stair), #2 project context (story settings, adjacent walls, stair type selected etc.) and #3 users design intent (the clicks made during the placement of the Stair and the mouse movement indicating the next intended click). Applying all these inputs offers either one specific Stair design (that ARCHICAD shows as a live preview changing as the user moves its mouse for the next click), or if the actual Stair design cannot be accomplished with the given input parameters, ARCHICAD runs analysis of several thousand possible parameter combinations for compliant Stair designs in the background and offers a selection of best of options for the User to choose from, on the fly (see FIG. 8). It is graphically indicated for the User which alternative design would require what parameter to be changed to resolve the parameter conflict offering the User a well-informed one-click resolution.

FIG. 10 is a computing machine 400 and a system applications module 500 in accordance with example embodiments. The computing machine 400 can correspond to any of the various computers, mobile devices, laptop computers, servers, embedded systems, or computing systems presented herein. The module 500 can comprise one or more hardware or software elements designed to facilitate the computing machine 400 in performing the various methods and processing functions presented herein. The computing machine 400 can include various internal or attached components such as a processor 410, system bus 420, system memory 430, storage media 440, input/output interface 450, and a network interface 460 for communicating with a network 470.

The computing machine 400 can be implemented as a conventional computer system, an embedded controller, a laptop, a server, a mobile device, a smartphone, a wearable computer, a customized machine, any other hardware platform, or any combination or multiplicity thereof. The computing machine 400 can be a distributed system configured to function using multiple computing machines interconnected via a data network or bus system.

The processor 410 can be designed to execute code instructions in order to perform the operations and functionality described herein, manage request flow and address mappings, and to perform calculations and generate commands. The processor 410 can be configured to monitor and control the operation of the components in the computing machine 400. The processor 410 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 410 can be a single processing unit, multiple processing units, a single processing core, multiple processing cores, special purpose processing cores, co-processors, or any combination thereof. According to certain embodiments, the processor 410 along with other components of the computing machine 400 can be a virtualized computing machine executing within one or more other computing machines.

The system memory 420 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 420 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 420. The system memory 430 can be implemented using a single memory module or multiple memory modules. While the system memory 430 is depicted as being part of the computing machine 400, one skilled in the art will recognize that the system memory 430 can be separate from the computing machine 400 without departing from the scope of the subject technology. It should also be appreciated that the system memory 430 can include, or operate in conjunction with, a non-volatile storage device such as the storage media 440.

The storage media 440 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 440 can store one or more operating systems, application programs and program modules such as module 500, data, or any other information. The storage media 440 can be part of, or connected to, the computing machine 400. The storage media 440 can also be part of one or more other computing machines that are in communication with the computing machine 400 such as servers, database servers, cloud storage, network attached storage, and so forth.

The system applications module 500 can comprise one or more hardware or software elements configured to facilitate the computing machine 400 with performing the various methods and processing functions presented herein. The module 500 can include one or more sequences of instructions stored as software or firmware in association with the system memory 430, the storage media 440, or both. The storage media 440 can therefore represent examples of machine or computer readable media on which instructions or code can be stored for execution by the processor 410. Machine or computer readable media can generally refer to any medium or media used to provide instructions to the processor 410. Such machine or computer readable media associated with the module 500 can comprise a computer software product. It should be appreciated that a computer software product comprising the module 500 can also be associated with one or more processes or methods for delivering the module 500 to the computing machine 400 via the network 470, any signal-bearing medium, or any other communication or delivery technology. The module 500 can also comprise hardware circuits or information for configuring hardware circuits such as microcode or configuration information for an FPGA or other PLD. In one exemplary embodiment, module 500 can include stair controller module that implements stair controller algorithm 100, stair variation algorithm 150, and stair constructor algorithm 250.

The input/output (“I/O”) interface 450 can be configured to couple to one or more external devices, to receive data from the one or more external devices, and to send data to the one or more external devices. Such external devices along with the various internal devices can also be known as peripheral devices. The I/O interface 450 can include both electrical and physical connections for coupling the various peripheral devices to the computing machine 400 or the processor 410. The I/O interface 450 can be configured to communicate data, addresses, and control signals between the peripheral devices, the computing machine 400, or the processor 410. The I/O interface 450 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 450 can be configured to implement only one interface or bus technology. Alternatively, the I/O interface 450 can be configured to implement multiple interfaces or bus technologies. The I/O interface 450 can be configured as part of, all of, or to operate in conjunction with, the system bus 420. The I/O interface 450 can include one or more buffers for buffering transmissions between one or more external devices, internal devices, the computing machine 400, or the processor 410.

The I/O interface 450 can couple the computing machine 400 to various input devices including mice, touch-screens, scanners, electronic digitizers, sensors, receivers, touchpads, trackballs, cameras, microphones, keyboards, any other pointing devices, or any combinations thereof. The I/O interface 450 can couple the computing machine 400 to various output devices including video displays, speakers, printers, projectors, tactile feedback devices, automation control, robotic components, actuators, motors, fans, solenoids, valves, pumps, transmitters, signal emitters, lights, and so forth.

The computing machine 400 can operate in a networked environment using logical connections through the network interface 460 to one or more other systems or computing machines across the network 470. The network 470 can include wide area networks (WAN), local area networks (LAN), intranets, the Internet, wireless access networks, wired networks, mobile networks, telephone networks, optical networks, or combinations thereof. The network 470 can be packet switched, circuit switched, of any topology, and can use any communication protocol. Communication links within the network 470 can involve various digital or an analog communication media such as fiber optic cables, free-space optics, waveguides, electrical conductors, wireless links, antennas, radio-frequency communications, and so forth.

The processor 410 can be connected to the other elements of the computing machine 400 or the various peripherals discussed herein through the system bus 420. It should be appreciated that the system bus 420 can be within the processor 410, outside the processor 410, or both. According to some embodiments, any of the processor 410, the other elements of the computing machine 400, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A stair modeling system comprising:
a computer-usable non-transitory storage resource, standard stair design parameters and associated values stored in the storage resource; and
a processor communicatively coupled to the storage resource, wherein the processor executes application code instructions stored in the storage resource that are configured to cause the system to:
receive at least one of a standard stair design parameter and an associated user defined value and at least one stair design parameter and associated user defined value;
generate stair design data associated with dynamically manageable objects, each object displayable within a graphical setting, the stair design data defined at least partially by at least one of the standard stair design parameter and associated user defined value and the at least one stair design parameter and associated user defined value;
process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters; and
regenerate stair design data.

2. The stair modeling system of claim 1 wherein
the standard stair design parameters and associated values define parameters and values for at least one of riser height, going width, 2 times riser plus 1 going, a riser/going ratio, riser plus going, stair pitch, walking line, and automatic landing length; and
the standard stair design parameters and associated user defined values and stair design parameters and associated user defined values define parameters and values for at least one of riser height, going width, 2 times riser plus 1 going, a riser/going ratio, riser plus going, stair pitch, and automatic landing length, story height, number of landings, turning types (landing, winder with equal angles, winder with equal goings), segment types (run, landing, winder with equal angles, winder with equal goings), number of steps, stair width, number of risers, and polyline values.

3. The stair modeling system of claim 2 wherein the processor executes application code instructions that are stored in the storage resource to further cause the system to:
process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively adjust size of going;
automatically calculate lead and trail offsets within the standard requirements; and
adjust length of polyline segments while keeping the segment directions intact.

4. The stair modeling system of claim 2 wherein the processor executes application code instructions that are stored in the storage resource to further cause the system to:
process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
if there are at least 3 segments in a stair and the turning types are landings, then attempt to switch the inner segments from flight to landing (thus merging two adjacent turnings) one-by-one, if segments are shorter than 3× the stair width;
if there are at least 3 segments in a stair and the turning types are winders with equal goings and they are unidirectional turnings (all turnings are clockwise, or all turnings are counterclockwise), then attempt to switch the inner segments from flight segment to winder segment (thus merging two adjacent turnings) one-by-one, if segments are shorter than 3× the stair width;
offset the walking line of the stair within a range permitted by the set rules and standards;
select a different winding type;
adjust the length of the first segment of the polyline;
offset the walking line of the stair and adjust the length of the first segment of the polyline; and
select a different winding type and adjust the length of the first segment of the polyline.

5. The stair modeling system of claim 2 wherein the processor executes application code instructions that are stored in the storage resource to further cause the system to:
process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively adjust total number of steps;
iteratively adjust the length of the first segment of the polyline and the total number of steps;
iteratively adjust length of every other segment of the polyline one by one; and
iteratively adjust length of every other segment of the polyline one by one and the length of the first segment of the polyline.

6. The stair modeling system of claim 1 wherein the processor executes application code instructions that are stored in the storage resource to further cause the system to recalculate at least one of the standard stair design parameter and associated user defined value and at least one stair design parameter and associated user defined value in multiple ways in order to determine more than one alternative stair design data.

7. The stair modeling system of claim 6 wherein the recalculating at least one of the standard stair design parameter and associated user defined value and at least one stair design parameter and associated user defined value satisfy standard requirements defined by the standard stair design parameters and associated values.

8. The stair modeling system of claim 1 wherein the computer-usable non-transitory storage resource includes at least one set of standard stair design parameters and associated values with each set defining standards and rules for a geographic region.

9. A method of operating a stair modeling system comprising:
storing standard stair design parameters and associated values stored in the storage resource;
receiving at least one of user defined standard stair design parameters and associated values and user defined stair design parameters and associated values;
generating stair design data associated with dynamically manageable objects, each object displayable within a graphical setting, the stair design data defined at least in part by at least one of the user defined standard stair design parameters and associated values and the user defined stair design parameters and associated values;
processing the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters; and
regenerating stair design data.

10. The method of operating a stair modeling system according to claim 9 wherein
the standard stair design parameters and associated values define parameters and values for at least one of riser height, going width, 2 times riser plus 1 going, a riser/going ratio, riser plus going, stair pitch, and automatic landing length; and
the user defined standard stair design parameters and associated parameters and user defined stair design parameters and associated values define parameters and values for at least one of riser height, going width, 2 times riser plus 1 going, a riser/going ratio, riser plus going, stair pitch, and automatic landing length, story height, number of landings, turning types (landing, winder with equal angles, winder with equal goings), segment types (run, landing, winder with equal angles, winder with equal goings), number of steps, stair width, number of risers, and polyline values.

11. The method of operating a stair modeling system according to claim 10 further comprising processing the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively adjust size of going;
automatically calculate lead and trail offsets within the standard requirements; and
adjust length of polyline segments while keeping the segment directions intact.

12. The method of operating a stair modeling system according to claim 10 further comprising processing the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively change the first turning type from winder turn to symmetrical landing turning type and then the following turnings, one by one;
iteratively change the first turning type from winder turn to non-symmetrical landing turning type and then the following turnings, one by one; and
iteratively change winder turnings one by one to Non-Symmetrical Landings, together with the first segment being flexible.

13. The method of operating a stair modeling system according to claim 10 further comprising processing the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
change the turning type for all turnings to symmetrical landing;
change the turning type for all turnings to non-symmetrical landing and change any winder segments (both Equal Angle or Equal Going) to Run segments;
mark all segments as flexible; and
change the turning type for all turnings to non-symmetrical landing and change any winder segments (both Equal Angle or Equal Going) to Run segments and adjust the length of all segments.

14. The method of operating a stair modeling system according to claim 9 further comprising recalculating at least one of the standard stair design parameter and associated user defined value and at least one stair design parameter and associated user defined value in multiple ways in order to determine more than one alternative stair design data.

15. The method of operating a stair modeling system according to claim 14 further comprising recalculating at least one of the standard stair design parameter and associated user defined value and at least one stair design parameter and associated user defined value to satisfy standard requirements defined by the standard stair design parameters and associated values.

16. A non-transitory computer readable storage medium comprising a set of computer instructions executable by a processor for operating a system for stair modeling, computer instructions configured to:
receive at least one of user defined standard stair design parameters and associated values and user defined stair design parameters and associated values;
generate stair design data associated with dynamically manageable objects, each object displayable within a graphical setting, the stair design data and control data defined by at least one of the user defined standard stair design parameters and associated values and the user defined stair design parameters and associated values;
process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters; and
regenerate stair design data;
wherein the standard stair design parameters and associated values define parameters and values for at least one of riser height, going width, 2 times riser plus 1 going, a riser/going ratio, riser plus going, stair pitch, and automatic landing length; and
wherein the user defined standard stair design parameters and associated parameters and user defined stair design parameters and associated values define parameters and values for at least one of riser height, going width, 2 times riser plus 1 going, a riser/going ratio, riser plus going, stair pitch, and automatic landing length, story height, number of landings, landing types (landing, winder with equal angles, winder with equal goings), segment types (run, landing, winder with equal angles, winder with equal goings), number of steps, stair width, number of risers, and polyline values.

17. The non-transitory computer readable storage medium as recited in claim 16 further including computer instructions configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively adjust size of going;
automatically calculate lead and trail offsets within the standard requirements; and
adjust length of pre-selected polyline segments while keeping the segment directions intact.

18. The non-transitory computer readable storage medium as recited in claim 16 further including computer instructions configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
if there are at least 3 segments in a stair and the turning types are landings, then attempt to switch the inner segments from flight to landing (thus merging two adjacent turnings) one-by-one, if segments are shorter than 3× the stair width;
if there are at least 3 segments in a stair and the turning types are winders with equal goings and they are unidirectional turnings (all turnings are clockwise, or all turnings are counterclockwise), then attempt to switch the inner segments from flight segment to winder segment (thus merging two adjacent turnings) one-by-one, if segments are shorter than 3× the stair width;
offset the walking line of the stair within allowed range;
select a winding turning from a group of pre-stored winding turnings;
adjust the length of the first segment of the polyline;
offset the walking line of the stair and adjust the length of the first segment of the polyline; and
select a winding turning from a group of pre-stored winding turnings and adjust the length of the first segment of the polyline.

19. The non-transitory computer readable storage medium as recited in claim 16 further including computer instructions configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively adjust total number of steps;
iteratively adjust the length of the first segment and the total number of steps;
iteratively adjust length of every other segment one by one; and
iteratively adjust length of every other segment one by one and the length of the first segment.

20. The non-transitory computer readable storage medium as recited in claim 16 further including computer instructions configured to process the stair design data by comparing the at least one of the standard stair design parameter and associated user defined value and the at least one stair design parameter and associated user defined value with the standard stair design parameters and associated values and recalculating at least one of the user defined values associated with the standard stair design parameters and stair design parameters in a manner that satisfies requirements of the standard stair parameters by performing at least one of:
iteratively change the first turning type from winder turn to symmetrical landing turning type and then the following turnings, one by one;
iteratively change the first turning type from winder turn to non-symmetrical landing turning type and then the following turnings, one by one;
iteratively change winder turnings one by one to Non-Symmetrical Landings, together with the first segment being flexible;
change the turning type for all turnings to symmetrical landing;
change the turning type for all turning to non-symmetrical landing and change any winder segments (both Equal Angle or Equal Going) to Run segments;
mark all segments as flexible; and
change the turning type for all turnings to non-symmetrical landing and change any winder segments (both Equal Angle or Equal Going) to Run segments and adjust the length of all segments.
